(19) United States
(12) Patent Application Publication
(10) Pub. No.: US 2007/0231553 A1
(43) Pub. Date: Oct. 4, 2007

(54) REMOVABLE PROTECTIVE COVER

(75) Inventors: Klaus Hartig, Avoca, WI (US); Leah M. Miller, Avoca, WI (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: CARDINAL CG COMPANY, Eden Prairie, MN (US)

(21) Appl. No.: 11/688,036

(22) Filed: Mar. 19, 2007

Related U.S. Application Data
(60) Provisional application No. 60/786,500, filed on Mar. 28, 2006.

(51) Int. Cl. C09D 5/00; B32B 17/06

(52) U.S. Cl. 428/216; 427/154; 427/372.2; 427/337; 428/426; 428/702; 428/698; 428/408

(57) ABSTRACT

A substrate bearing a removable cover is provided. The removable cover includes two or more removable films, wherein at least one film is removable by a different removing process than another film. For example, in some cases one film is an organic film removable by heat treatment and another film is an inorganic film durable to heat treatment but is soluble to a mild acid or a mild base.

### CROSS-REFERENCE TO RELATED APPLICATION

The present application claims priority to U.S. application Ser. No. 60/786,500, filed Mar. 28, 2006, the entire disclosure of which is incorporated herein by reference.

### FIELD OF THE INVENTION

The present invention provides a removable cover for substrates, such as glass and the like. More particularly, the invention provides a removable cover that can be applied over a substrate surface to protect such surface from contamination.

### BACKGROUND OF THE INVENTION

It can be difficult to prevent glass and other substrates from mechanical damage, such as scratching and/or chemical contamination during manufacturing, shipping, storing, installing, finishing and other processes. Contamination can occur in different ways. For example, manufacturing, storage and transport environments sometimes contain organics, residues and other chemicals that can contaminate the substrates being produced. For example, various solvents, curing products, and sealants used in manufacturing processes sometimes produce residues that can accumulate on the glass being produced. Handling equipment used in producing glass products can also leave marks on the glass. For example, vacuumized suction cups are commonly used to handle glass sheets and can sometimes leave suction cup marks on the glass.

Some manufacturers have deposited a removable film over the glass sheet in order to protect the glass from contamination and/or scratching. For example, inorganic films have been used as removable covers and are described in U.S. Pat. Nos. 6,902,813 and 6,921,579, the entire contents of each which are incorporated herein by reference. Inorganic films are often removable by a washing procedure, but not by heat treatment. Organic films are also used as removable covers, as described in U.S. Pat. No. 6,682,773, the entire contents of which is incorporated by reference herein. These carbon-containing organic films are often removable by heat treatment, but not by a washing procedure.

Some inorganic covers are sometimes too soft or too thin to provide adequate protection, particularly against scratching. As a result, inorganic covers are often applied as thicker films to provide complete protection. However, thicker films can sometimes be difficult to remove. For example, when removing a thicker film by a washing procedure, the film material may foam up, which causes the material to be redeposited onto the substrate. A window washer sometimes invests a considerable amount of time in washing to ensure that the material is completely removed from the substrate. Organic films often provide better protection from scratching than inorganic films. However, removable organic protective covers are generally removed earlier during the manufacturing process, for example during tempering. Thus, once the substrate is removed from the tempering oven or other heat-treating apparatus, the substrate once again remains exposed and vulnerable to scratching and/or chemical contamination.

Thus, it would be desirable to provide a removable cover for glass substrates that protects the glass during substantially all of the manufacturing processes. It is also desirable to provide a removable cover that is easy to remove.

### SUMMARY OF THE INVENTION

In some embodiments, a glass substrate bearing a removable cover is provided, wherein, the cover comprises at least an inorganic material and an organic material, wherein the inorganic material is removable by a different removal process than the organic material. The inorganic material can comprise an oxide and/or nitride that is soluble in a mild acid or a mild base. In some cases, the inorganic material comprises zinc oxide. The organic material can comprise a carbon-containing material removable by heat treatment. In some cases, the carbon-containing material consists essentially of carbon. The organic material can also be a separator material removable by washing with water. The separator material can comprise a water soluble polymer, a plasticizer, one or more alcohols, a plurality of particles and water.

In some cases, the removable cover comprises two or more films and the inorganic material comprises an inorganic film and the organic material comprises an organic film. The removable cover can comprise, from the substrate surface outwardly, the inorganic film and the organic film. Each the inorganic film and organic film can have a thickness of less than 100 angstroms. In certain cases, the inorganic film has a thickness of between about 20 angstroms and about 50 angstroms and organic film has a thickness of between about 10 angstroms and about 60 angstroms.

In other cases, the removable cover comprises a mixed film including both the inorganic and organic material. The mixed film can include an outer portion and an inner portion, wherein the organic material is present at a higher concentration in the outer portion and the inorganic material is present at a higher concentration in the inner portion. In certain cases, the outer portion comprises substantially organic material and the inner portion comprises substantially inorganic material. The mixed film can also be a graded film, wherein, moving outwardly from the substrate surface, there is a gradually increasing concentration of organic material and a gradually decreasing concentration of inorganic material.

In some cases, a functional coating is positioned between the substrate and the removable cover. The functional coating can be a low-emissivity coating or even a photocatalytic coating. In certain cases, the functional coating includes an outermost dielectric film, the dielectric film comprising an inorganic material that is not present in the removable cover and is not removable by the removal process used to remove the inorganic material or the removable cover.

Further, a protective film can be positioned between the functional coating and the removable cover, the protective film comprising a material that is durable to a mild acid or mild base. In some cases, the protective film comprises carbon. The protective film can also have a thickness of less than 100 angstroms. In some cases, inorganic material overlies the protective film and prevents the protective film from being burned off when the coated substrate is subjected to a glass tempering that burns off organic material overlying the inorganic material.

A method for depositing a removable cover is also provided. In some embodiments, the method comprises providing a glass substrate bearing a functional coating and depositing a removable cover over the functional coating, the removable cover comprising at least an inorganic material and an organic material, wherein the inorganic material is removable by a different removal process than the organic material. In some cases, the method further comprises depositing a protective film comprising carbon between the functional coating and the removable cover.

The depositing a removable cover can comprise depositing, from the substrate surface outwardly, an inorganic film and an organic film. In some cases, the inorganic film and organic film are sputter-deposited. The organic film can be deposited by sputtering a target comprising carbon. The organic film can also be deposited by sputtering a target applying a separator material comprising a water soluble polymer, a plasticizer, one or more alcohols, a plurality of particles and a water.

The depositing a removable cover can also comprise depositing a mixed film of inorganic and organic material. In some cases, the depositing a mixed film comprises sputtering a target comprised of inorganic material in a carbon-containing atmosphere. In other cases, the depositing a mixed film comprises co-sputtering at least one target comprising organic material and at least one target comprising organic material. In other cases, the depositing a mixed film comprises sputtering an increasing concentration of organic material and a decreasing concentration of inorganic material.

A method for protecting a coated glass substrate is also provided. In some embodiments, the method comprises, in sequence, depositing a removable cover over the substrate, the removable cover comprising at least an inorganic material and an organic material, wherein the inorganic material is removable by a different removal process than the organic material, removing the organic material while leaving intact the inorganic material, and removing the inorganic material.

In some cases, the depositing a removable cover comprises depositing, from the substrate outwardly, an inorganic film and an organic film. The depositing an organic film can comprise depositing a carbon-containing film removable by heat treatment or depositing a separator removable by washing with water. The depositing an inorganic film can comprise depositing an oxide and/or nitride that is removable by washing with a mild acid or mild base. In other cases, the depositing a removable cover comprises depositing a mixed film including both the inorganic and organic material.

In some cases, the removing the organic material while leaving intact the inorganic material comprises subjecting the substrate to heat treatment. In other cases, the removing comprises washing the substrate with water. In some cases, the removing the inorganic material comprises washing exposed inorganic material with a mild acid or a mild base.

### BRIEF DESCRIPTION OF THE DRAWINGS

FIG. 1 is a schematic cross-sectional view of a substrate having a coated surface carrying a removable cover in accordance with an embodiment of the invention;

FIG. 2 is a schematic cross-sectional view of a substrate having two coated surfaces each carrying a removable cover in accordance with another embodiment of the invention;

FIG. 3 is a schematic cross-sectional view of a substrate having a coated surface carrying both a protective film and a removable cover in accordance with yet another embodiment of the invention;

FIG. 4 is a schematic cross-sectional view of a substrate having a coated surface carrying a removable cover in accordance with another embodiment of the invention;

FIG. 5 is a schematic cross-sectional view of a substrate having a coated surface carrying a removable cover in accordance with yet another embodiment of the invention;

FIG. 6 is a schematic cross-sectional view of a substrate having a coated surface carrying a removable cover in accordance with yet another embodiment of the invention;

FIG. 7 is a schematic cross-sectional view of a substrate having a coated surface carrying a removable cover in accordance with yet another embodiment of the invention;

FIG. 8 is a schematic cross-sectional view of a substrate having a coated surface carrying a removable cover in accordance with yet another embodiment of the invention;

FIG. 9 is a partially broken-away schematic cross-sectional side view of a multiple-pane insulating glass unit that includes a window pane having two coated surfaces in accordance with certain embodiments of the invention;

FIG. 10 is a partially broken-away perspective view of a window pane carrying a functional coating, the pane being mounted in an exterior wall of a building in accordance with certain embodiments of the invention;

FIG. 11 is a schematic side view of a sputtering chamber that is adapted for use in certain methods of the invention; and

FIG. 12 is a schematic side view of a dual-direction sputtering chamber that is adapted for use in certain methods of the invention.

### DETAILED DESCRIPTION OF THE PREFERRED EMBODIMENTS

The following detailed description is to be read with reference to the drawings, in which like elements in different drawings have like reference numbers. The drawings, which are not necessarily to scale, depict selected embodiments and are not intended to limit the scope of the invention. Skilled artisans will recognize that the given examples have many alternatives that fall within the scope of the invention.

Many embodiments of the invention involve a coated substrate. A wide variety of substrates types are suitable for use in the invention. In some embodiments, the substrate 10 is a sheet-like substrate having generally opposed first 12 and second 14 major surfaces. For example, the substrate can be a sheet of transparent material (i.e., a transparent sheet). The substrate, however, is not required to be a sheet, nor is it required to be transparent.

The substrate can optionally be a component of any of a variety of building materials. Examples of anticipated applications include embodiments wherein the substrate is a sash (e.g., a window sash or a door sash), a siding panel (e.g., an aluminum siding panel), a tent panel, a tarpaulin (e.g., a fluorocarbon polymer tarpaulin), a plastic film (e.g., a fluorocarbon plastic film), a roofing shingle, a window blind (such as a metal, plastic, or paper window blind), a paper screen (e.g., a shoji), a railing, a baluster, or an escutcheon. In one embodiment, the substrate is a ceramic tile, such as a wall, ceiling, or floor tile. In another embodiment, the substrate is a glass block. A variety of suitable glass blocks can be obtained commercially from Saint-Gobain Oberland (Koblenz, Germany). In still other embodiments, the substrate is a polyester film, a polyethylene film, a terephthalate film, etc. Suitable films of this nature can be obtained commercially from Nippon Soda Co., Ltd. (Tokyo, Japan). In further embodiments, the substrate is a fence or wall, such as a noise-reduction fence or wall.

For many applications, the substrate will comprise a transparent (or at least translucent) material, such as glass or clear plastic. For example, the substrate is a glass sheet (e.g., a window pane) in certain embodiments. A variety of known glass types can be used, and soda-lime glass will commonly be preferred. In certain preferred embodiments, the substrate is part of a window, skylight, door, shower door or other glazing. In some cases, the substrate is part of an automobile windshield, an automobile side window, an exterior or interior rear-view mirror, a bumper, a hubcap, a windshield wiper, or an automobile hood panel, side panel, trunk panel, or roof panel. In other embodiments, the substrate is a piece of aquarium glass, a plastic aquarium window, or a piece of greenhouse glass. In a further embodiment, the substrate is a refrigerator panel, such as part of a refrigerator door or window.

Substrates of various sizes can be used in the present invention. Commonly, large-area substrates are used. Certain embodiments involve a substrate 10 having a major dimension (e.g., a length or width) of at least about 0.5 meter, preferably at least about 1 meter, perhaps more preferably at least about 1.5 meters (e.g., between about 2 meters and about 4 meters), and in some cases at least about 3 meters. In some embodiments, the substrate is a jumbo glass sheet having a length and/or width that is between about 3 meters and about 10 meters, e.g., a glass sheet having a width of about 3.5 meters and a length of about 6.5 meters. Substrates having a length and/or width of greater than about 10 meters are also anticipated.

In some embodiments, the substrate 10 is a generally square or rectangular glass sheet. The substrate in these embodiments can have any of the dimensions described in the preceding paragraph and/or in the following paragraph. In one particular embodiment, the substrate is a generally rectangular glass sheet having a width of between about 3 meters and about 5 meters, such as about 3.5 meters, and a length of between about 6 meters and about 10 meters, such as about 6.5 meters.

Substrates of various thicknesses can be used in the present invention. In some embodiments, the substrate 10 (which can optionally be a glass sheet) has a thickness of about 1-5 mm. Certain embodiments involve a substrate 10 with a thickness of between about 2.3 mm and about 4.8 mm, and perhaps more preferably between about 2.5 mm and about 4.8 mm. In one particular embodiment, a sheet of glass (e.g., soda-lime glass) with a thickness of about 3 mm is used. In one group of embodiments, the thickness of the substrate (which can be glass, plastic, or another material) is between about 4 mm and about 20 mm. Thicknesses in this range, for example, may be useful for aquarium tanks (in which case, the substrate can optionally be glass or acrylic). When the substrate is float glass, it will commonly have a thickness of between about 4 mm and about 19 mm. In another group of embodiments, the substrate is a thin sheet (e.g., of glass) having a thickness of between about 0.35 mm and about 1.9 mm. Embodiments of this nature can optionally involve the substrate 10 being a sheet of display glass or the like.

A removable cover for protecting a surface of a substrate is provided. The cover includes two or more materials, wherein at least one material is removable by a different removal process than another material. Each material can be part of a single protective film or part of one or more films of a multi-layer protective film. Likewise, each film can be a discrete layer of each material or a mixed film containing mixtures of two or more materials.

At least one of the materials is removable by a different removal process than another material. For example, in some cases, one of the materials can be removable by heat treatment wherein another material can be durable to heat treatment. The material durable to heat treatment can be removable by a process other than heat treatment, e.g., by a washing process. Likewise, in other cases, one of the materials can be removable by washing with one washing material whereas another material can be durable to washing with that type of washing material. For example, one material can be removable by washing with water whereas another material is durable to water but removable by washing with another washing material, such as a mild acid or a mild base. The inventors have found that a removable cover comprised of two or more materials removable by different processes provides exceptional protection for the substrate surface. Additionally, each material of the cover protects the surface during desired steps during the manufacturing process before it is removed.

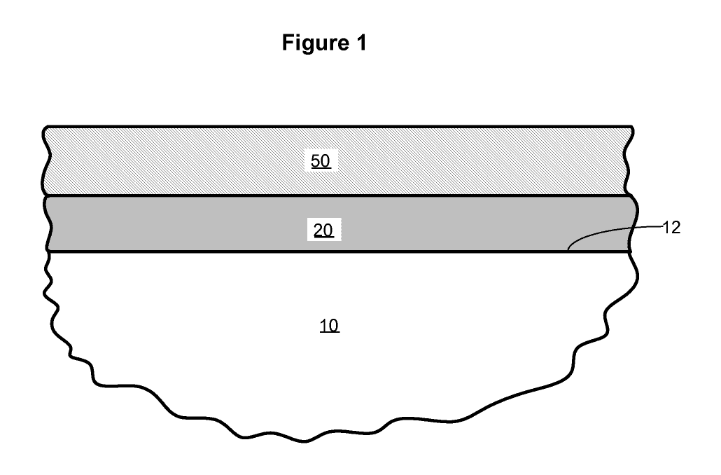

Preferably, all of the substrate surfaces that desire protection are coated with the removable cover. The cover can be provided over only the substrate surface or over one or more functional coatings deposited on the substrate surface. In many cases, the cover is provided over a substrate surface bearing a functional coating. For example, such an embodiment is shown in FIG. 1, where a substrate 10 is provided bearing a functional coating 20 on a surface 12. A cover 50 is provided over the functional coating 20. The functional coating 20 can include a single film or a plurality of films. Any desired functional coating known in the art can be used. The functional coating 20 is preferably not removable by the removing process used to remove the cover material directly overlying the coating 20. There is virtually no limit on the types of functional coatings that would benefit from temporary protection. Thus, the removable cover can be used to protect coatings of any type and nature.

In some cases, the functional coating 20 is a low-emissivity film. Low-emissivity coatings are known in the art and particularly suitable coatings are described in U.S. patent application Ser. Nos. 09/728,435 and 11/360,266, the entire teachings of each of which are incorporated herein by reference. In other cases, the functional coating 20 is a low-maintenance coating, for example a photocatalytic coating or a hydrophilic coating. Low-maintenance coatings are also known in the art and particularly suitable coatings are described in U.S. patent application Ser. Nos. 11/021,482, 11/179,178, 11/179,852, 11/129,820 and 11/293,032, the entire contents of each which are incorporated herein by reference. In certain embodiments, the functional coating 20 is a photocatalytic coating. The photocatalytic coating is preferably a titania-containing coating.

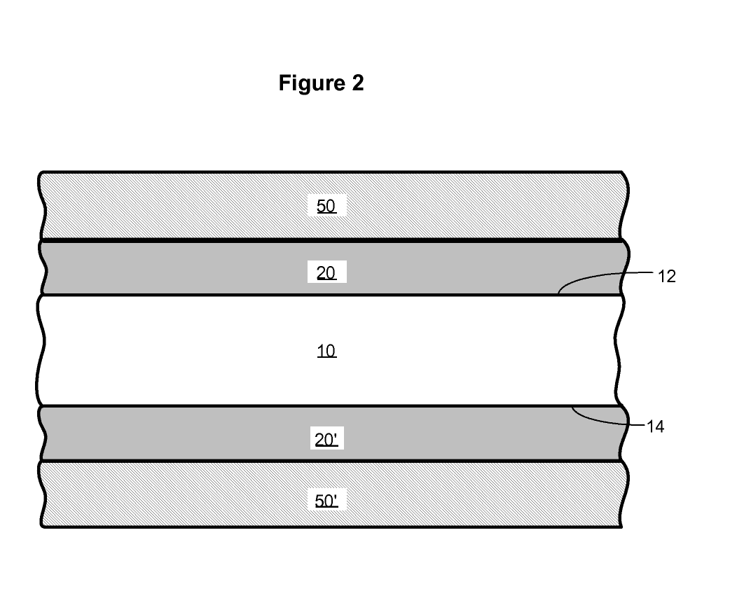

In other cases, a functional coating is provided on one of the major surfaces of the substrate and another functional coating is provided on an opposite major surface thereof, and a removable cover is provided over one or both functional coatings. FIG. 2 illustrates an embodiment wherein the substrate 10 is provided bearing a functional coating 20 on one surface 12 and a functional coating 20′ on an opposite surface 14 thereof. A cover 50 is provided upon the functional coating 20 and another cover 50′ is provided upon the functional coating 20′.

In certain embodiments, the surface 12 is a surface destined to be exposed to an outdoor environment, for example to periodic contact with rain. A coating deposited on such a surface may be exposed to organic materials, which are sometimes deposited on the coating. The functional coating provided on such a surface is preferably a low-maintenance coating. The low-maintenance coating helps to remove organic material deposited thereon. When the surface 12 is to be exposed to an outdoor environment, the surface 14 is a surface to be exposed to either an indoor environment or to an interpane space of an IG unit. In some cases, the functional coating 20′ provided on this surface 14 is a low-emissivity coating. A multi-layer cover can be provided upon each the low-maintenance coating and the low-emissivity coating to temporarily protect these coatings during desired steps in the manufacturing process. Of course, these removable covers will be removed once they have served their protective functions, so that once the substrate has been installed into a window frame (or has otherwise been placed in its final destination), the covers are no longer present.

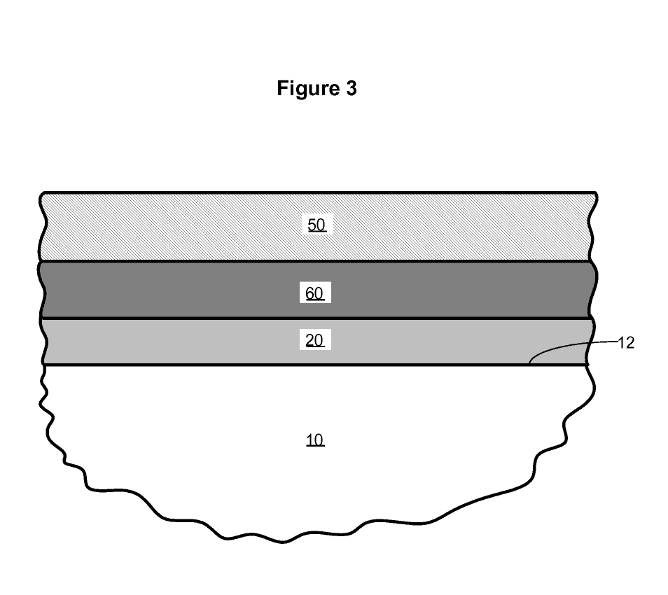

In certain embodiments, as illustrated in FIG. 3, a protective film 60 can be deposited between the removable cover 50 and the underlying functional film 20. The protective film 60 is preferably not removed during manufacturing, so the film serves to permanently protect the underlying functional coating. Such a film 60 is preferably used in cases where the underlying functional coating 20 is not a low-maintenance coating. Low maintenance coatings function best when they are exposed directly to contaminants in the outdoor environment. As a result, it is desirable to not leave any film remaining over the low-maintenance coating. In some cases, the film 60 is provided over a low-emissivity coating.

The protective film 60 can be any film which withstands the removal process used to remove material of the cover 50 that directly overlies the film 60. For example, when the overlying material is removable by a particular washing process, the film 60 is preferably durable to that washing process, so that it is not removed when the material is removed. In certain embodiments, an inorganic film part of the cover overlies a carbon-containing film 60. In some cases, the inorganic film is removable by washing with a mild acid or a mild base and the film 60 is durable to a mild acid or a mild base. Also, in cases where the film 60 is a carbon-containing film and an outer film 54 removable by heat treatment is provided over the film 52, the film 60 will not be removed by that same heat treatment as long as it remains protected (i.e., covered by) by the overlying film 52.

In most cases, the protective film 60 remains on the surface permanently. That is, once the overlying material of the cover is removed, the substrate is not again subjected to any kind of removing treatment to remove the protective film 60. The protective film can be deposited over the functional coating using any film deposition method known in the art. In some cases, the film 60 is deposited by sputtering. In preferred embodiments, the protective film is deposited so that it has a thickness of between about 10 angstroms and about 60 angstroms. The protective film can be provided with any of the embodiments described for the removable cover 50.

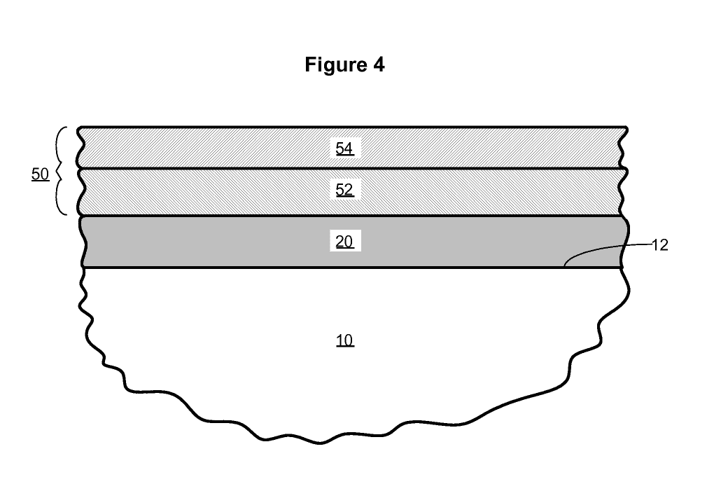

In some embodiments, the removable cover includes two or more removable films comprised of different materials, wherein one film is removable by a different process than another film. Such an embodiment is illustrated in FIG. 4, wherein the cover includes an inner film 52 and an outer film 54. The inner film 52 is removable by a different process than the outer film 54. In certain cases, the inner film 52 and the outer film 54 each have a thickness of less than about 100 angstroms. In some cases, the inner film 52 has a thickness of between about 20 angstroms and about 50 angstroms and the outer film 54 has a thickness of between about 10 angstroms and about 60 angstroms. The use of more than one film allows for each film to be deposited at a lower thickness, so that each film can be easily removed. Although each film itself may be of a lower thickness, the combined films of the cover have a thickness which provides exceptional protection for the underlying surface.

In some cases, one of the films 52 or 54 can be comprised of a material that is removable by heat treatment wherein the other film can be comprised of a material that is durable to heat treatment. The film durable to heat treatment can be removable by any process other than heat treatment, for example removable by a washing process. In other cases, one of the films 52 or 54 film can be comprised of a material that is removable by washing with one particular washing material and another film is durable to that washing material. For example, one film can be removable by washing with water whereas another film can be durable to water but removable by washing with an acidic or basic washing solution. Any combination of films can be used so long as one film is removable by a different process than another film.

In embodiments where one film is removable by heat treatment and another film is durable to heat treatment, the film removable by heat treatment may be an organic film and the film durable to heat treatment may be an inorganic film. As used herein, the term “organic film” means a film having substantially its entire thickness being one or more organic materials. Likewise, the term “inorganic film” means a film having substantially its entire thickness being one or more inorganic materials. Either the organic film or inorganic film can also include one or more identification materials, such as colorants or fragrant materials. Certain suitable identification materials or presence indicators are described in U.S. patent application Ser. No. 10/866,936, the entire contents of which are incorporated herein by reference.

In certain cases, the organic film is a carbon-containing film. The carbon-containing film is removable by subjecting the coated substrate to heat treatment. The carbon-containing film, in some embodiments, is preferably greater than about 50 percent weight carbon, more preferably greater than about 75 percent weight carbon, still more preferably greater than about 90 percent weight carbon and most preferably about 100 weight percent carbon based on the total weight of the carbon containing coating. Thus, in certain embodiments the carbon containing film consists essentially of carbon.

During heat treatment, the carbon oxidizes and is thereby removed from the surface. Suitable heat treatments include but are not limited to tempering, annealing, bending and thermal combustion. In preferred embodiments, the coated substrate is subjected to tempering, which also removes an exposed organic film. During tempering, glass is subject to elevated temperatures before being cooled at a controlled rate. For example, tempered glass is commonly heated to temperatures at or near the melting point of glass. More specifically, tempering temperatures on the order of 600 degrees Celsius are common. Moreover, glass may be subjected to these high temperatures for extended periods of time (e.g., hours).

Likewise, in certain cases, the inorganic film is a film that is stable in the presence of water having a neutral pH, but breaks down, dissolves, softens, or otherwise is soluble in the presence of a washing material that is at least slightly acidic or slightly basic. For example, the inorganic film may be formed of material that is soluble in a mild acid or a mild base. In a preferred embodiment, the film is formed of a material that is soluble in a weak organic acid, such as common household vinegar. While the acidity of different vinegars may vary, the pH of common household vinegar is estimated to be about 3. Alternatively, the inorganic film can be formed of a material that is soluble in a weak base, such as a weak ammonia solution. For example, in one such embodiment, the film comprises a material that is soluble in a common household ammonia solution, which is estimated to have a pH of between about 11 and about 12.5.

In some embodiments, the inorganic film comprises an oxide or nitride that is soluble in a mild acid or a mild base. In preferred embodiments, the inorganic film comprises a metal oxide film. The term “metal” is used herein to refer to metals and metalloids or semi-metals. Preferred metal oxides include oxides of metals selected from the group consisting of zinc, bismuth, cadmium, iron and nickel. The oxides of this group are stable in water, but tend to break down in the presence of weak acids or weak bases. Thus, they are readily removed when washed with washing materials that are mildly acidic or mildly basic.

In certain embodiments, the inorganic film comprises zinc oxide. Zinc oxide works well as a removable film for a number of reasons. For example, it has been found that zinc oxide is effective in protecting the underlying surface against contamination at a thickness of less than about 100 angstroms. Further, it has been discovered that zinc oxide is particularly easy to remove in a complete and uniform manner when washed with a weak acid or a weak base (e.g., vinegar). Zinc oxide can also be sputtered at a very high rate and is consequently deposited at a relatively low cost.

In one preferred embodiment, the inorganic film comprises a sputtered zinc oxide film having a thickness of at least about 25 angstroms, more preferably between about 25 angstroms and about 60 angstroms, and perhaps optimally between about 25 angstroms and about 45 angstroms. Sputtered zinc oxide films in this thickness range have been found to be particularly effective in protecting substrate surfaces against contamination while being reliably removable in a complete, uniform manner upon the application of a weak acid or a weak base. Moreover, such zinc oxide covers tend to be durable to glass tempering procedures, and thus will not be removed along with an overlying carbon-containing film during tempering.

In certain embodiments, the inner film 52 is an inorganic film durable to heat treatment and the outer film 54 is an organic film removable by heat treatment. The inner film 52 is preferably deposited directly over the functional coating 20. In these cases, the functional coating 20 beneath the film 52 is preferably formed of material that is durable to the desired washing material and/or washing procedure, so the film 52 can be removed without disturbing the underlying functional coating 20. For example, the functional coating 20 preferably has sufficient mechanical durability to withstand the rigors of common window washing techniques without becoming unacceptably scratched or otherwise damaged. In cases where the film 52 is removed by washing with a mild acid or mild base, t is also desirable for the functional coating surface to be resistant to attack by (i.e., stable in the presence of) a washing fluid that is at least slightly acidic or basic. Preferably, this surface is resistant to attack by a mild acid or a mild base. Optimally, its is entirely unaffected by contact with mild acids and mild bases.

The film 52 can be deposited over the substrate or functional coating using any film deposition method known in the art. In certain cases, the film is applied by sputtering. Sputtering techniques and equipment are well known in the art. In certain cases, the film 52 can be advantageously formed of a sputtered metal oxide film. A sputtered metal oxide film can be deposited using various sputter deposition processes. One possibility for depositing such a film would be to sputter a target formed of the desired metal oxide itself in a non-reactive atmosphere, such as argon. However, targets formed of metal oxide tend not to sputter as reliably as pure metal targets, since metal oxides are far less conductive than their respective metals. Thus, it can be difficult to reliably sputter a metal oxide target in a DC sputtering apparatus. As a consequence, metal oxide films are commonly deposited by sputtering a metallic target in an oxidizing atmosphere. For example, a film of zinc oxide can be deposited by sputtering a zinc target in an oxidizing atmosphere (e.g., oxygen at a pressure of about 8×10⁻³ mbar).

The outer organic film 54 can also be deposited over the inner film 52 using any film deposition method known in the art. In some cases, the film 54 is deposited by sputtering. For example, a sputtering line can be provided wherein one of the cathode bays has a carbon-containing or graphite sputtering target. Likewise, a target can be sputtered in a carbon-containing atmosphere to provide a carbon-containing film. In other cases, the film 54 is deposited by carbon arc deposition.

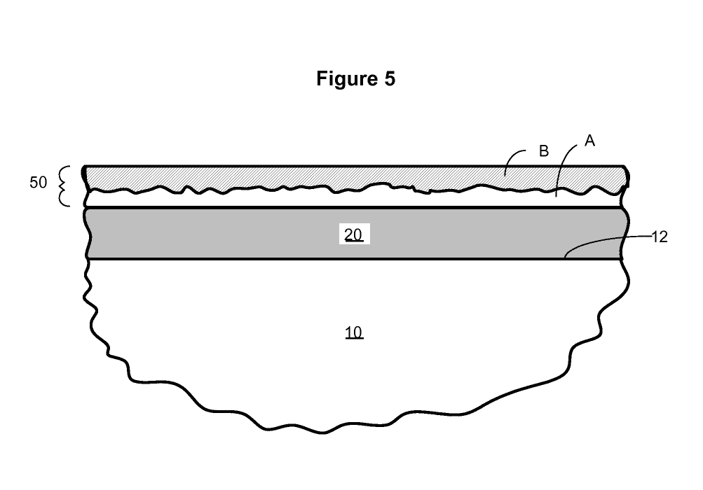

In other embodiments, the removable cover is provided as a single film comprised of two or more materials wherein one material is removable by a different removing process than another material. FIG. 5 depicts an embodiment of the invention wherein a removable cover 50 includes a portion of a first material A and a portion of a second material B. Each the first material A and the second material B are part of the same film and are removable by different processes. In some cases, the first material A is an inorganic material durable to heat treatment and the second material B is an organic material removable by heat treatment. In such cases, the coated substrate can be subjected to heat treatment at a desired stage during manufacturing to remove the outer second material B. The first material A survives heat treatment and serves to protect the coated substrate until its protective functions are no longer desired. This material A can be later removed by a washing process, such as by washing with a mild acid or a mild base.

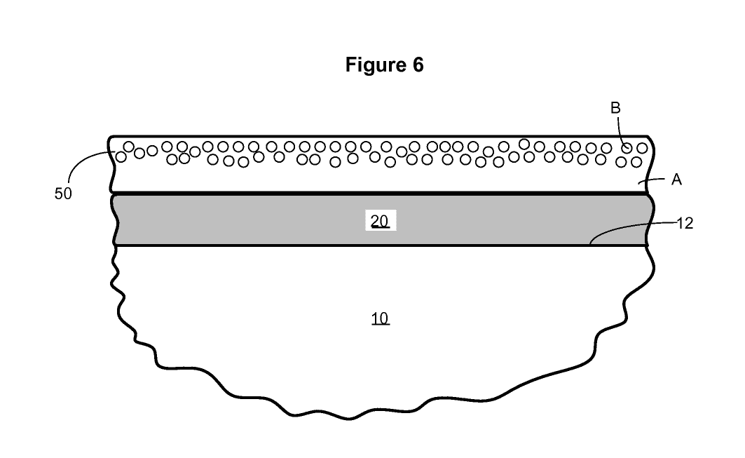

FIG. 6 depicts another embodiment wherein a removable cover 50 includes a mixture of a first material A and a second material B. In preferred cases, as illustrated in this Figure, the first material A is an inorganic material and the second material B is an organic material. The second material B is preferably present in a higher concentration at an outermost portion of the cover 50. In certain embodiments, the removable cover 50 is provided as a mixed film containing metal, carbon, oxygen and/or nitrogen. For example, the film can be a layer of metal oxide containing carbon, a metal nitride containing carbon, or a metal oxynitride containing carbon. The first material A is preferably a metal oxide, metal nitride or metal oxynitride and the second material B is preferably carbon. In particularly preferred embodiments, the cover includes titanium oxide and carbon, zinc oxide and carbon or silicon nitride and carbon. In preferred cases, the carbon concentration in the film is greatest in the outermost region. For example, in some cases, the film can be a graded film, wherein, moving outwardly from the substrate surface, there is a gradually increasing concentration of carbon. Thus, the carbon concentration is greatest at the outermost region of the cover 50.

The removable cover 50 of FIG. 6 also serves to protect the coated substrate during desired manufacturing processes. In cases where the first material A is an inorganic material and the second material B is an organic material, the cover can then be subjected to heat treatment to burn the organic material out of the cover, leaving the inorganic material with less (e.g., substantially no) organic material before the substrate is installed in an IG unit or otherwise used for its intended purpose. Once the substrate is installed, the remaining inorganic material (e.g., metal oxide, metal nitride or metal oxynitride) can be removed by a process other than heat treatment, for example a washing process. Removable films of this embodiment are preferably less than about 100 angstroms, more preferably less than about 75 angstroms, and optimally less than about 50 angstroms.

Removable films containing metal, carbon, oxygen and/or nitrogen can be deposited, for example, by sputtering a metal target in a coater wherein a last coating region has a carbon containing atmosphere. The carbon-containing atmosphere can advantageously be a carbon dioxide atmosphere. Thus, a coated substrate passes through one or more sputtering bays as shown in FIG. 13. When a film comprising metal oxide and carbon is deposited, the substrate is first passed through one or more sputtering bays having a metal target that is sputtered in a reactive atmosphere. The reactive atmosphere preferably comprises argon and oxygen. Then, the substrate is passed through one or more last sputtering bays having a same metal target that is sputtered in a carbon-containing atmosphere. The carbon containing atmosphere preferably includes carbon dioxide and oxygen and optionally argon. Likewise, when a film comprising metal nitride and carbon is deposited, the substrate is first passed through one or more sputtering bays having a metal target that is sputtered in a nitrogen atmosphere. Then, the substrate is passed through one or more last sputtering bays having a same metal target that is sputtered in a carbon-containing atmosphere. The carbon containing atmosphere preferably includes carbon dioxide and nitrogen. In certain embodiments, the mixed film is deposited sot that the organic material is present at a proportion preferably at least about 15 atomic % by atomic ration to the total amount of film material. In particularly preferred cases, the organic material is present at a proportion of at least about 30 atomic % and more preferably at least about 40 atomic %. In some cases, the organic material and inorganic material are present at substantially equal atomic %, for example each at about 50 atomic %.

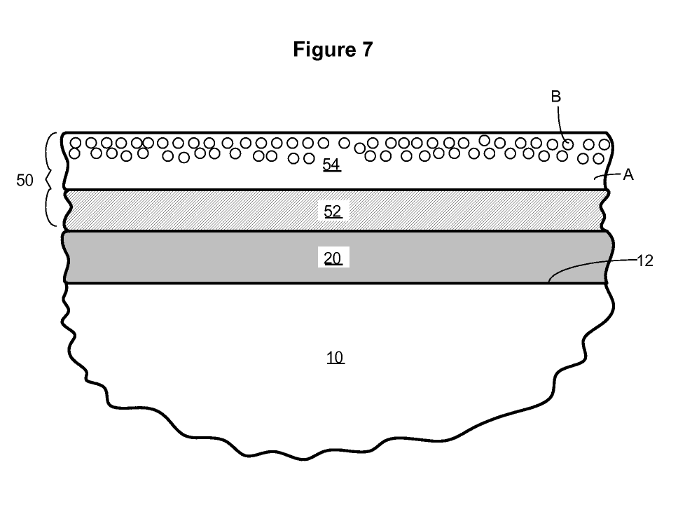

With reference to FIG. 7, in some embodiments, a removable cover 50 includes an inner dielectric film 52 and an outer film 54 having a mixture of a first material and a second material. The outer film can have any of the characteristics already described for the removable cover of FIG. 6. In some embodiments, the inner dielectric film 52 is formed of a dielectric material that is not present in the outer film 54. For example, in some embodiments, the outer film 54 comprises titanium oxide and carbon or silicon nitride and carbon whereas the inner film 52 comprises a zinc oxide, tin oxide or zinc tin oxide film.

In other embodiments, the inner dielectric film 52 is formed of a dielectric material that is present in the outer film 54. In certain examples, the inner dielectric film 54 comprises titanium oxide and the outer film 54comprises titanium oxide and carbon. In other examples, the inner dielectric film 54 comprises silicon nitride and the outer film 54 comprises silicon nitride and carbon. The outer and inner films can be graded into each other in some embodiments.

In certain embodiments, the inner film 52 is the outermost dielectric film of a low-emissivity film stack. For example, the inner film 52 can be part of the following film stack, from the substrate surface outwardly: base film region infrared-reflecting film region middle coat/infrared-reflection film region film 52. Additionally, a removable cover 50 as in FIG. 7 can be deposited, for example, by sputtering a metal target in a sputtering chamber wherein the last coating region has a carbon containing atmosphere. The carbon containing atmosphere can be advantageously a carbon dioxide atmosphere.

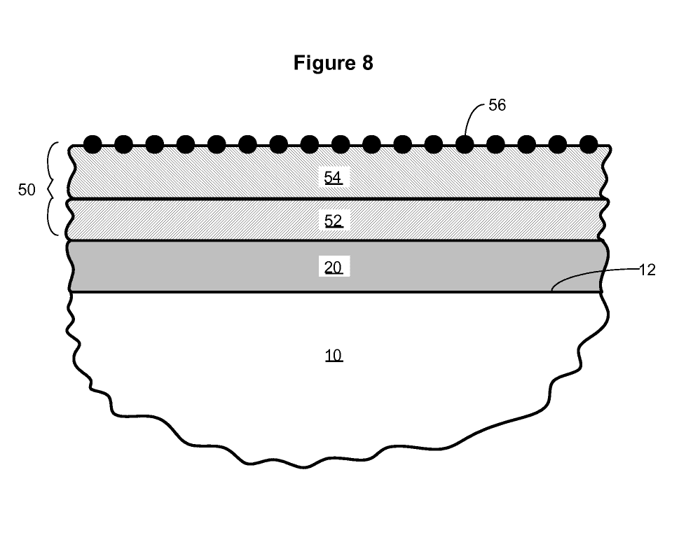

FIG. 8 illustrates an embodiment wherein a protective cover 50 has an inner film 52 formed of one material and an outer film 54 formed of a separator material. Suitable separator materials are described in U.S. patent application Ser. No. 10/313,543, the entire contents which are herein incorporated by reference. The outer film 54 comprised of separator material is again removable by a different removing process than the inner film 52. In a preferred embodiment, the separator material comprises a film 54 and a plurality of particles 56 adhered to the film 54.

The outer film 54 preferably comprises a material removable by water. The film is preferably a water soluble polymer, a plasticizer, one or more alcohols, a plurality of particles and water. The water soluble polymer can be any suitable polymer allowing for the film to be easily removed by an aqueous solution. In a preferred embodiment, the water soluble composition comprises polyvinyl alcohol (PVA). Another suitable polymer includes, but is not limited to, polyvinyl chloride. In certain embodiments, the plasticizer comprises glycerin. Glycerin is a commercial product whose principal component is glycerol.

The one or more alcohols preferably comprises one or more alcohols each having a carbon content of less than 10 carbons. Even more preferably, the one or more alcohols each have a carbon content of less than 6 carbons. Alcohols that my be used in the composition include, but are not limited to, methanol, ethanol, propanol, propenol, butanol, butenol, pentanol, hexanol, heptanol, octanol, nonanol and decanol. In a preferred embodiment, the one or more alcohols comprises a combination of ethanol, methanol, and isopropyl alcohol.

The plurality of particles 56 may include any particles capable of keeping two sheets of glass separated. The particles 56 may comprise various materials without deviating from the spirit and scope of the present invention. Examples of materials which may be suitable in some applications include LUCITE.

In preferred embodiments, the composition of film 54 comprises polyvinyl alcohol, glycerin, one or more alcohols and water. In an even more preferred embodiment, the film composition comprises between about 1% to about 15% polyvinyl alcohol, between about 0.2% to 0.8% glycerin, up to 25% one or more alcohols, and the remainder comprising water. In an even more preferred embodiment, the film composition comprises between about 2% to a 5% polyvinyl alcohol, between about 1% to 2% glycerin, up to about 10% alcohol and the remainder comprising water. In another preferred embodiment, the film composition comprises polyvinyl alcohol, glycerin, ethanol, methanol, isopropyl alcohol and water. In an even more preferred embodiment, the film composition comprises 2% to about 5% polyvinyl alcohol, between about 1% to 2% glycerin, about 5% ethanol, about less than 1% methanol, about les than 1% isopropyl alcohol, and the remainder comprising water.

In certain embodiments, the film 54 has a film thickness selected so that the film may by easily removed with water (e.g., when run through a conventional glass washer). In certain useful embodiments, the film 54 has a thickness of less than about 8.0 microns, preferably less than about 1.0 microns and perhaps optimally less than about 0.8 microns. The film 52 in the embodiment of FIG. 8 preferably comprises a material that is durable to washing with water. In certain cases, the film 52 comprises a material that is soluble in a mild acid or mild base. In such cases, the film 54 is first removed by washing with water, wherein the water leaves intact the underlying film 52. The film 52 is later removed by washing with a mild acid or a mild base.

In any of the embodiments illustrated in FIGS. 5-8, a protective film 60 as described and illustrated in FIG. 3 can be deposited between the removable cover 50 and the underlying functional film 20. Again, the protective film is preferably not removed during manufacturing, so the film serves to permanently protect the underlying functional coating.

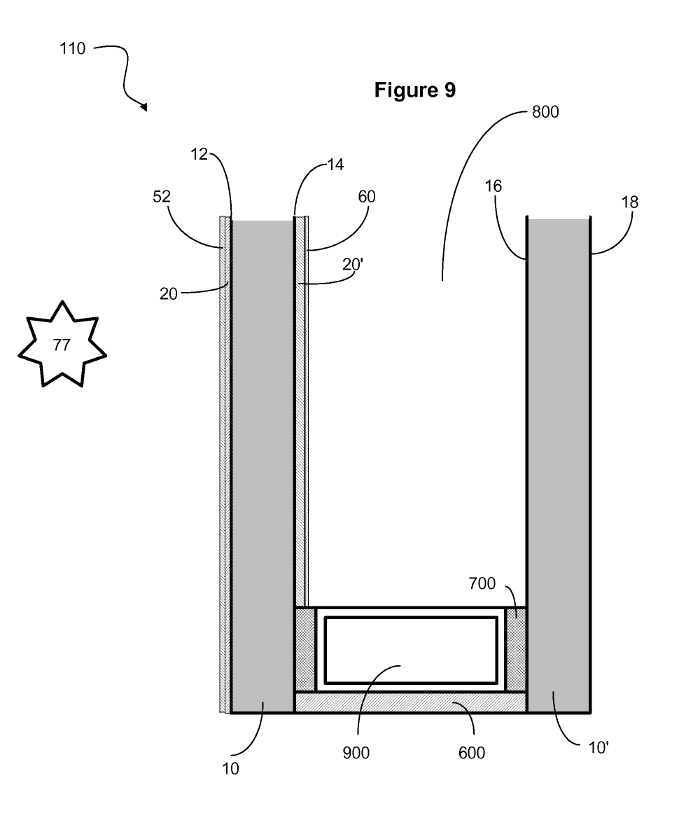

With reference to FIG. 9, the substrate 10 can be part of an insulating glass unit 110. Typically, an insulating glass unit 110 has an exterior pane 10 and an interior pane 10′ separated by a between-pane space 800. A spacer 900 (which can optionally be part of a sash) is commonly provided to separate the panes 10 and 10′. The spacer can be secured to the interior surfaces of each pane using an adhesive 700. In some cases, an end sealant 600 is also provided. In the illustrated embodiment, the exterior pane 10 has an exterior surface 12 and an interior surface 14. The interior pane 10′ has an interior surface 16 and an exterior surface 18. The pane 10 can be mounted in a frame (e.g., a window frame) such that the exterior surface 12 is exposed to an outdoor environment. Interior surfaces 14 and 16 are both exposed to the atmosphere in the between-pane space 800 of the insulating glass unit.

In some cases, the exterior surface 12 of the substrate 10 positioned in the IG unit shown in FIG. 9 includes a low-maintenance coating 20. Likewise, the interior surface 14 of the same substrate 10 includes a low-emissivity coating 20′. Of course, any other functional coating can be provided on either the exterior surface 12 or the interior surface 14. A removable cover of the invention will have provided protection to either of these surfaces during the manufacturing of the substrate 12. The removable cover can have characteristics of any of the embodiments already described. In some cases, any film of the removable cover will be removed before installation of the substrate into an IG unit. This is particularly true with any films provided on surface 14 of the substrate, which will be facing the interpane space of the IG unit. In other cases, though, one or more films may be still protecting the surface 12 of the IG unit, which surface is destined for exposure to an outdoor environment. In most cases, at least one film will be remaining on the surface 12 to provide protection to the low-maintenance coating 20 until it is desired to expose and use the properties of that low-maintenance coating.

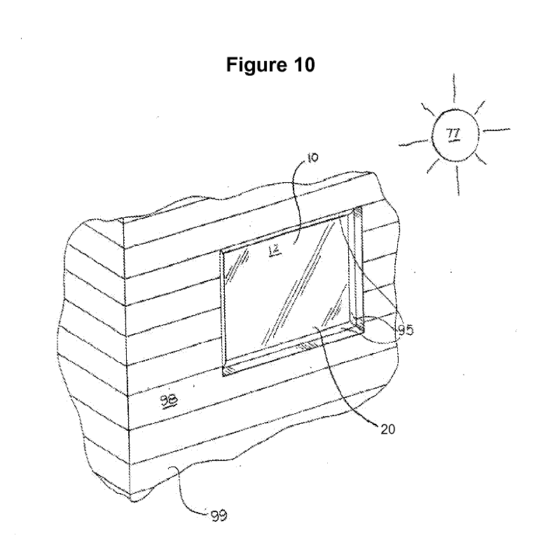

FIG. 10 exemplifies embodiments wherein the substrate 10 (which may be a glass pane) is a window pane that is mounted on a window frame 95 (e.g., in an exterior wall 98 of a building 99). In certain applications, the coated first surface (i.e., surface 12) of such a window carries a functional coating 20 and will be exposed to an outdoor environment with periodic contact with rain. Preferably, the functional coating in this case is a hydrophilic or low-maintenance coating. A removable cover would have been provided on this surface 12 to provide protection of the functional coating 20 during manufacturing. However, films part of this removable cover are generally removed during manufacturing. However, in some cases, one of those films may remain on this surface 12 to protect the functional coating 20 until it is completely installed in the window frame 95 and is ready to be used. In some embodiments, such a remaining film is an inorganic film removable by washing. Once the substrate is completely installed as a window frame 95, the underlying functional coating is preferably exposed to the outdoor environment. This is particularly true in cases where a hydrophilic functional coating is used, as hydrophilic coatings are more effective at self-cleaning if the dirt comes into direct contact with the coating itself.

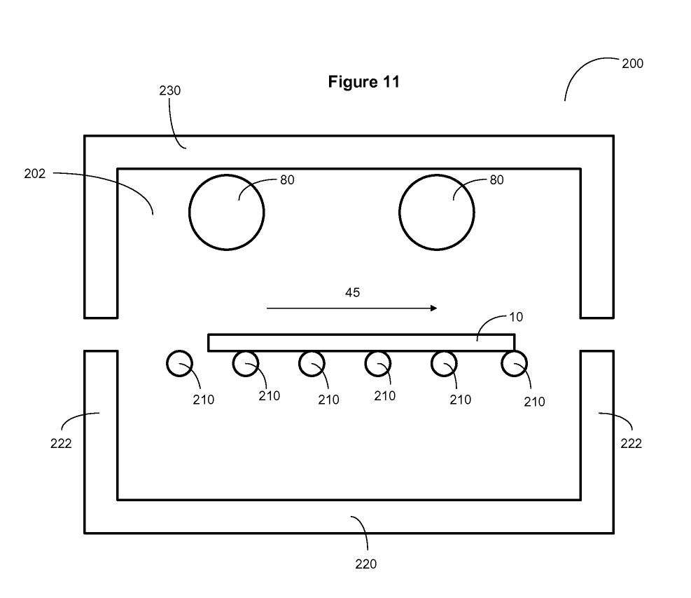

Methods for producing coated substrates are also provided. Each film of the removable cover can be deposited by a variety of well known coating techniques. Suitable coating techniques include, but are not limited to, chemical vapor deposition (CVD), plasma enhanced chemical vapor deposition, pyrolytic deposition and sputtering. In certain embodiments, the films are deposited by sputtering, optionally at a low temperature (e.g., while maintaining the substrate at below about 250 degrees Celsius, and perhaps more preferably below 200 degrees Celsius). Sputtering is well known in the present art. FIG. 11 depicts an exemplary magnetron sputtering chamber 200. Magnetron sputtering chambers and related equipment are commercially available from a variety of sources (e.g., Leybold). Useful magnetron sputtering techniques and equipment are described in U.S. Pat. No. 4,166,018, issued to Chapin, the entire teachings of which are incorporated herein by reference.

The illustrated sputtering chamber 200 includes a base (or “floor”) 220, a plurality of side walls 222, and a ceiling (or “top lid” or “cover”) 230, together bounding a sputtering cavity 202. In FIG. 11, two upper targets 280 are mounted above the path of substrate travel 45. The substrate 10 is conveyed along the path of substrate travel 45 during film deposition, optionally over a plurality of spaced-apart transport rollers 210. In FIG. 11, two upper targets are provided, although this is by no means required. For example, a single upper or lower target could alternatively be used in each chamber. Moreover, the chamber can include one or more upper and/or lower planar targets, although cylindrical targets are shown.

Preferably, the sputtering of the films of the cover is carried out while maintaining the substrate at a temperature of less than about 250 degrees Celsius, and more preferably less than 200 degrees Celsius (e.g., without supplemental heating of the substrate). In such cases, the coating preferably is sputter deposited without any supplemental means for delivering energy to a growing film (e.g., without any heating of the substrate beyond that which occurs normally from the plasma and ion bombardment of conventional sputtering). In other cases, a film is deposited by a sputter deposition technique that includes a supplemental heating (or other supplemental energy delivery).

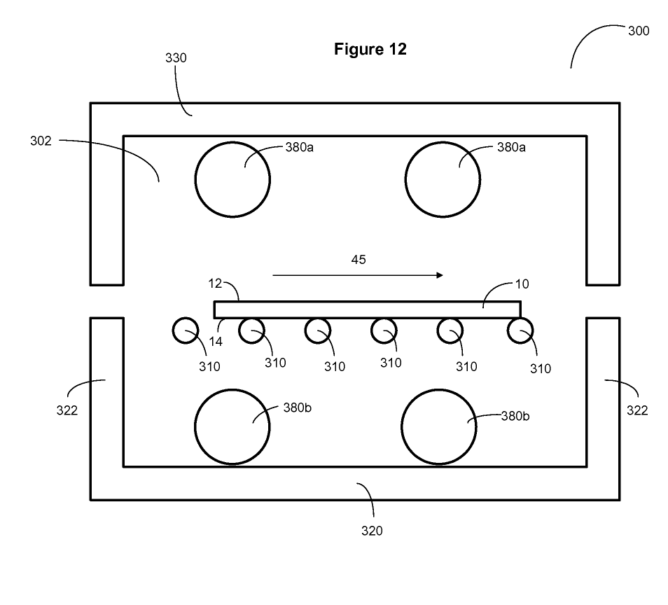

In certain embodiments, protective covers are provided on opposite surfaces of a single substrate, and the sputtering of the films of these covers are carried out in a dual direction sputtering chamber. FIG. 12 illustrates an exemplary dual direction sputtering chamber 300. Dual direction sputtering chambers are described in U.S. patent application Ser. Nos. 09/868,542, 10/911,155, and 10/922,719, the entire teachings of each of which are incorporated herein by reference. The illustrated sputtering chamber 300 includes a base (or “floor”) 320, a plurality of side walls 322, and a ceiling (or “top lid” or “cover”) 330, together bounding a sputtering cavity 302. Two upper targets 380a are mounted above the path of substrate travel 45 and two lower targets 380b are mounted below the path of substrate travel. The substrate 10 is conveyed along the path of substrate travel 45 during film deposition, optionally over a plurality of spaced-apart transport rollers 310. Both the upper targets 380a and lower targets 380b are sputtered simultaneously to deposit one film on one surface of the substrate and another film on the opposite surface. In certain embodiments, the upper targets 380a are sputtered to downwardly deposit one or more films of a removable multi-layer overcoat on the surface 12 of the substrate. The lower targets 380b are also sputtered to upwardly deposit a multi-layer removable cover on the surface 14 of the substrate.

While a preferred embodiment of the present invention has been described, it should be understood that various changes, adaptations and modifications may be made therein without departing from the spirit of the invention and the scope of the appended claims.

What is claimed is:

1. A glass substrate bearing a removable cover, the cover comprising at least an inorganic material and an organic material, wherein the inorganic material is removable by a different removal process than the organic material.

2. The glass substrate of claim 1 wherein the removable cover comprises two or more films and the inorganic material comprises an inorganic film and the organic material comprises an organic film.

3. The glass substrate of claim 2 wherein the removable cover comprises, from the substrate surface outwardly, the inorganic film and the organic film.

4. The glass substrate of claim 3 wherein each the inorganic film and organic film have a thickness of less than 100 angstroms.

5. The glass substrate of claim 4 wherein the inorganic film has a thickness of between about 20 angstroms and about 50 angstroms and organic film has a thickness of between about 10 angstroms and about 60 angstroms.

6. The glass substrate of claim 1 wherein the removable cover comprises a mixed film including both the inorganic and organic material.

7. The glass substrate of claim 6 wherein the mixed film has an outer portion and an inner portion, wherein the organic material is present at a higher concentration in the outer portion and the inorganic material is present at a higher concentration in the inner portion.

8. The glass substrate of claim 7 wherein the outer portion comprises substantially organic material and the inner portion comprises substantially inorganic material.

9. The glass substrate of claim 6 wherein the mixed film is a graded film, wherein, moving outwardly from the substrate surface, there is a gradually increasing concentration of organic material and a gradually decreasing concentration of inorganic material.

10. The glass substrate of claim 1 wherein the inorganic material comprises an oxide and/or nitride that is soluble in a mild acid or a mild base.

11. The glass substrate of claim 1 wherein the inorganic material comprises zinc oxide.

12. The glass substrate of claim 1 wherein the organic material is a carbon-containing material removable by heat treatment.

13. The glass substrate of claim 12 wherein the carbon-containing material consists essentially of carbon.

14. The glass substrate of claim 1 wherein the organic material is a separator material removable by washing with water.

15. The glass substrate of claim 14 wherein separator material comprises a water soluble polymer, a plasticizer, one or more alcohols, a plurality of particles and water.

16. The glass substrate of claim 1 further comprising a functional coating positioned between the substrate and the removable cover.

17. The glass substrate of claim 16 wherein the functional coating is a low-emissivity coating.

18. The glass substrate of claim 16 wherein the functional coating is a photocatalytic coating.

19. The glass substrate of claim 16 further comprising a protective film positioned between the functional coating and the removable cover, the protective film comprising a material that is durable to a mild acid or mild base.

20. The glass substrate of claim 19 wherein the protective film comprises carbon.

21. The glass substrate of claim 19 wherein the protective film has a thickness of less than 100 angstroms.

22. The glass substrate of claim 1 wherein inorganic material overlies the protective film and prevents the protective film from being burned off when the coated substrate is subjected to a glass tempering that burns off organic material overlying the inorganic material.

23. The glass substrate of claim 16 wherein functional coating includes an outermost dielectric film, the dielectric film comprising an inorganic material that is not present in the removable cover and is not removable by the removal process used to remove the inorganic material or the removable cover.

24. A method for depositing a removable cover, the method comprising:
providing a glass substrate bearing a functional coating;
depositing a removable cover over the functional coating, the removable cover comprising at least an inorganic material and an organic material, wherein the inorganic material is removable by a different removal process than the organic material.

25. The method of claim 24 wherein the depositing a removable cover comprises depositing, from the substrate surface outwardly, an inorganic film and an organic film.

26. The method of claim 25 wherein the depositing an inorganic film and organic film comprises sputter-depositing the inorganic film and organic film.

27. The method of claim 26 wherein the depositing the organic film comprises sputtering a target comprising carbon.

28. The method of claim 26 wherein the depositing the organic film comprises sputtering a target applying a separator material comprising a water soluble polymer, a plasticizer, one or more alcohols, a plurality of particles and a water.

29. The method of claim 24 wherein the depositing a removable cover comprises depositing a mixed film of inorganic and organic material.

30. The method of claim 29 wherein the depositing a mixed film comprises sputtering a target comprised of inorganic material in a carbon-containing atmosphere.

31. The method of claim 29 wherein the depositing a mixed film comprises co-sputtering at least one target comprising organic material and at least one target comprising organic material.

32. The method of claim 29 wherein the depositing a mixed film comprises sputtering an increasing concentration of organic material and a decreasing concentration of inorganic material.

33. The method of claim 24 further comprising depositing a protective film comprising carbon between the functional coating and the removable cover.

34. A method for protecting a coated glass substrate, the method comprising, in sequence:
depositing a removable cover over the substrate, the removable cover comprising at least an inorganic material and an organic material, wherein the inorganic material is removable by a different removal process than the organic material;
removing the organic material while leaving intact the inorganic material; and
removing the inorganic material.

35. The method of claim 34 wherein the depositing a removable cover comprises depositing, from the substrate outwardly, an inorganic film and an organic film.

36. The method of claim 35 wherein the depositing an organic film comprises depositing a carbon-containing film removable by heat treatment.

37. The method of claim 35 wherein the depositing an organic film comprises depositing a separator removable by washing with water.

38. The method of claim 35 wherein the depositing an inorganic film comprises depositing an oxide and/or nitride that is removable by washing with a mild acid or mild base.

39. The method of claim 34 wherein the depositing a removable cover comprises depositing a mixed film including both the inorganic and organic material.

40. The method of claim 34 wherein the removing the organic material while leaving intact the inorganic material comprises subjecting the substrate to heat treatment.

41. The method of claim 34 wherein the removing the organic material while leaving intact the inorganic material comprises washing the substrate with water.

42. The method of claim 34 wherein the removing the inorganic material comprises washing exposed inorganic material with a mild acid or a mild base.
